(19) United States
(12) Patent Application Publication
(10) Pub. No.: US 2007/0046406 A1
(43) Pub. Date: Mar. 1, 2007

(54) Active vibration isolation support system

(75) Inventors: Hideki Matsuoka, Saitama (JP); Hirotomi Nemoto, Saitama (JP)

Correspondence Address: CARRIER BLACKMAN AND ASSOCIATES, 24101 NOVI ROAD, SUITE 100, NOVI, MI, 48375, US

(73) Assignee: Honda Motor Co., Ltd., Tokyo (JP)

(21) Appl. No.: 11/504,529

(22) Filed: Aug. 15, 2006

(30) Foreign Application Priority Data
Aug. 30, 2005 (JP) JP 2005-249926

(51) Int. Cl. H01H 9/02

(52) U.S. Cl. 335/202

(57) ABSTRACT

In an active vibration isolation support system, a movable member is connected to an armature (movable core) of an actuator and moved out and back by the armature, the armature is housed in a sealed space, and a pressure of the sealed space is maintained at substantially atmospheric pressure by a flexible bag that is disposed within the sealed space and communicates with the atmosphere via a through hole formed in a wall defining the sealed space. Therefore, while preventing dust and water from entering the sealed space to prevent malfunction of the armature, a change of pressure is prevented in the sealed space to maintain a neutral position of the movable member, thereby controlling vibration of the movable member with a good precision.

### RELATED APPLICATION DATA

The present invention claims priority under 35 USC 119 based on Japanese patent application No. 2005-249926, filed on Aug. 30, 2005. The subject matter of this priority document is incorporated in its entirety by reference herein.

### BACKGROUND OF INVENTION

1. Field of the Invention

The present invention relates to an active vibration isolation support system comprising: an elastic body that receives a load from a vibrating body; a liquid chamber having a wall of which at least a part is formed from the elastic body; an actuator that moves out and back by receiving a supply of current according to a vibrational state of the vibrating body; and a movable member that is operated by an armature of the actuator so as to change a capacity of the liquid chamber; at least the armature of the actuator being housed in a sealed space that is cut off from the atmosphere, and the movable member facing the sealed space.

2. Description of Related Art

Such an active vibration isolation support system is known from, for example, Japanese Patent Application Laid-open No. 2004-293601. In this active vibration isolation support system, a space in which an armature of an actuator moves out and back is sealed, thereby preventing malfunction of the armature due to the entrance of dust or water.

However, in this conventional system, the armature of the actuator is disposed in the sealed space, which is sealed so that dust or water does not enter, and a part of a wall defining the sealed space is formed from a movable member that moves out and back by being connected to the armature. As a result, the pressure of the sealed space changes according to the ambient temperature or heat generated by the actuator itself Therefore, the movable member receives a resistance when it moves in a direction in which the difference between the pressure of the sealed space and the atmospheric pressure increases, and its neutral position rises. In addition, the movable member receives an urging force when it moves in a direction in which the difference between the pressure of the sealed space and the atmospheric pressure decreases, and its neutral position falls. As a result, a clearance beneath the armature changes, and thus a driving force generated by the actuator changes, leading to a problem that it becomes difficult to control vibration of the movable member with a good precision.

### SUMMARY

The present invention has been accomplished under the above circumstances, and it is an object thereof to provide an active vibration isolation support system in which a neutral position of an armature of an actuator does not change according to a change in pressure of a sealed space housing the armature, while preventing dust and water from entering the sealed space.

In order to achieve the above object, according to a first feature of the present invention, there is provided an active vibration isolation support system comprising: an elastic body that receives a load from a vibrating body; a liquid chamber having a wall of which at least a part is formed from the elastic body; an actuator that moves out and back by receiving a supply of current according to a vibrational state of the vibrating body; and a movable member that is operated by an armature of the actuator so as to change a capacity of the liquid chamber; at least the armature of the actuator being housed in a sealed space that is cut off from the atmosphere, and the movable member facing the sealed space, wherein a pressure cushioning member is provided for maintaining a pressure of the sealed space at substantially atmospheric pressure.

With the first feature, the pressure of the sealed space, which houses the armature of the actuator that makes the movable member of the active vibration isolation support system move out and back and which the movable member connected to the armature faces, is maintained at substantially atmospheric pressure by the pressure cushioning member. Therefore, it is possible to stabilize the neutral positions of the armature and the movable member by preventing the pressure of the sealed space from varying, while preventing malfunction of the armature by preventing dust or water from entering the sealed space, thereby performing control of the movable member by the actuator with a good precision.

According to a second feature of the present invention, in addition to the first feature, the pressure cushioning member comprises a flexible bag that is disposed within the sealed space and communicates with the atmosphere via a through hole formed in a wall defining the sealed space.

With the second feature, the pressure cushioning member comprises the flexible bag which is disposed within the sealed space and communicates with the atmosphere via the through hole formed in the wall defining the sealed space. Therefore, it is possible to maintain the pressure of the sealed space at substantially atmospheric pressure by expansion and contraction of the flexible bag which communicates with the atmosphere, even if the capacity of the sealed space changes as a result of the armature of the actuator making the movable member move out and back.

According to a third feature of the present invention, in addition to the first feature, the pressure cushioning member comprises a flexible bag that is disposed within the sealed space and communicates with the liquid chamber via a through hole formed in a wall defining the sealed space.

With the third feature, the pressure cushioning member comprises the flexible bag, which is disposed within the sealed space and communicates with the liquid chamber via the through hole formed in the wall defining the sealed space. Therefore, it is possible to maintain the pressure of the sealed space at substantially atmospheric pressure by expansion and contraction of the flexible bag which communicates with the liquid chamber at substantially atmospheric pressure, even if the capacity of the sealed space changes as a result of the armature of the actuator making the movable member move out and back.

A first elastic body 19 of an embodiment corresponds to the elastic body of the present invention, first and second liquid chambers 30 and 31 of the embodiment correspond to the liquid chamber of the present invention, a movable core 54 of the embodiment corresponds to the armature of the present invention, and bags 64 and 65 of the embodiment correspond to the pressure cushioning member of the present invention.

The above-mentioned object, other objects, characteristics, and advantages of the present invention will become apparent from preferred embodiments that will be described in detail below by reference to the attached drawings.

### BRIEF DESCRIPTION OF THE DRAWINGS

FIG. 1 to FIG. 4 show a first embodiment of the present invention, wherein

FIG. 1 is a vertical sectional view of an active vibration isolation support system;

FIG. 2 is an enlarged view of part 2 in FIG. 1 showing the flexible bag disposed in the sealed space and in communication with the atmosphere via a through hole formed in the actuator housing wall;

FIG. 3 is a diagram for explaining a method of fixing the bag of FIG. 2 within the sealed space; and

FIG. 4 is a flow chart for explaining the operation of the active vibration isolation support system.

FIG. 5 and FIG. 6 show a second embodiment of the present invention, wherein;

FIG. 5 is a diagram corresponding to FIG. 2 showing the flexible bag disposed in the sealed space and in communication with the liquid chamber via a through hole formed in the wall defining the sealed space; and

FIG. 6 is a diagram for explaining a method of fixing the bag of FIG. 5 within the sealed space.

### DETAILED DESCRIPTION

Selected illustrative embodiments of the invention will now be described in some detail, with reference to the drawings. It should be understood that only structures considered necessary for clarifying the present invention are described herein. Other conventional structures, and those of ancillary and auxiliary components of the system, are assumed to be known and understood by those skilled in the art.

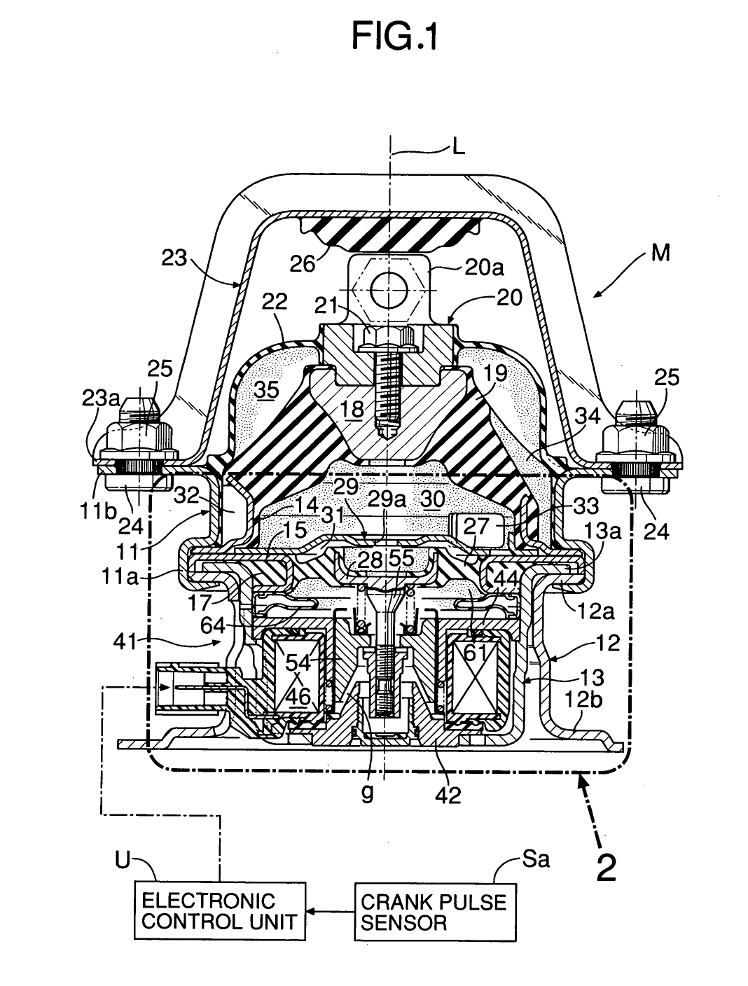

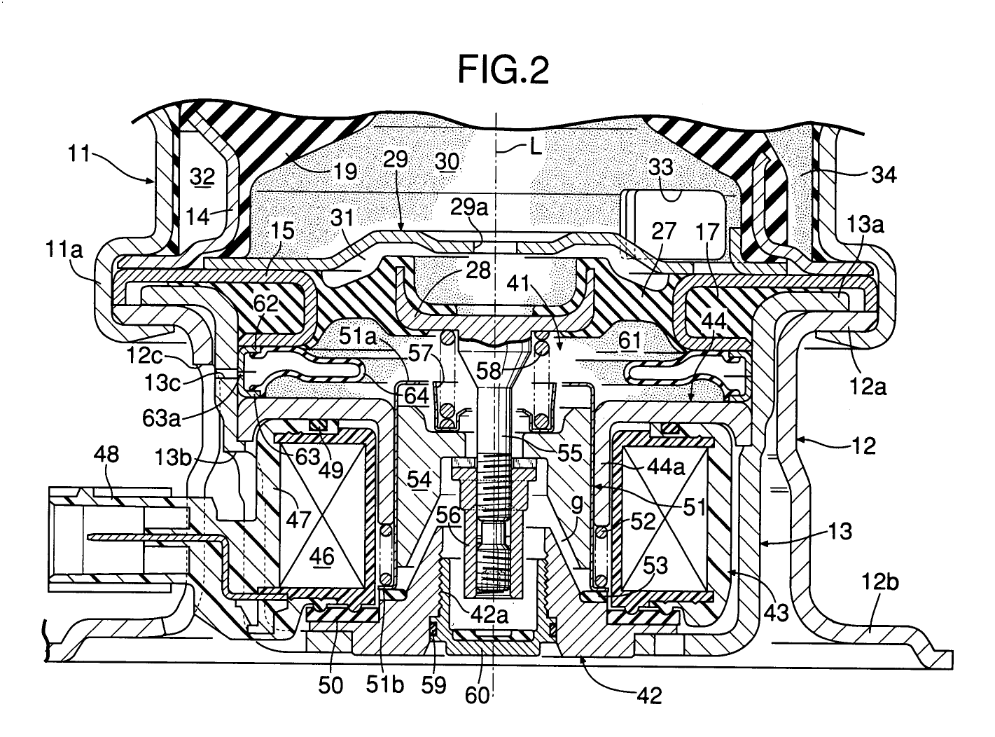

Referring to FIG. 1 and FIG. 2, an active vibration isolation support system M (active control mount) for elastically supporting an automobile engine in a vehicle body frame has a structure that is substantially symmetrical with respect to an axis L. In the active vibration isolation support system M, between a flange portion 11a at the lower end of a substantially cylindrical upper housing 11 and a flange portion 12a at the upper end of a substantially cylindrical lower housing 12, a flange portion 13a on the outer periphery of an upwardly opening substantially cup-shaped actuator case 13, an outer peripheral portion of an annular first elastic body support ring 14, and an outer peripheral portion of an annular second elastic body support ring 15 are superimposed and joined by crimping. In this process, an annular floating rubber member 17 is disposed between an upper part of the actuator case 13 and an inner face of the second elastic body support ring 15.

Joined by vulcanization bonding to the first elastic body support ring 14 and a first elastic body support boss 18 disposed on the axis L, are the lower end and the upper end of a first elastic body 19 made of a thick rubber. A diaphragm support boss 20 is fixed to an upper face of the first elastic body support boss 18 by a bolt 21. An outer peripheral portion of a diaphragm 22, whose inner peripheral portion is joined by vulcanization bonding to the diaphragm support boss 20, is joined by vulcanization bonding to the upper housing 11. An engine mounting portion 20a integrally formed on an upper face of the diaphragm support boss 20 is fixed to the engine (unillustrated). A vehicle body mounting portion 12b at the lower end of the lower housing 12 is fixed to the vehicle body frame (unillustrated).

A flange portion 23a at the lower end of a stopper member 23 is joined by bolts 24 and nuts 25 to a flange portion 11b at the upper end of the upper housing 11. The engine mounting portion 20a projectingly provided on the upper face of the diaphragm support boss 20 faces a stopper rubber member 26 attached to an upper inner face of the stopper member 23 so that the engine mounting portion 20a can abut against the stopper rubber member 26. When a large load is input to the active vibration isolation support system M, the engine mounting portion 20a abuts against the stopper rubber member 26, thereby suppressing excessive displacement of the engine.

An outer peripheral portion of a second elastic body 27, made of a membranous rubber, is joined by vulcanization bonding to the second elastic body support ring 15. A movable member 28 is embedded in and joined by vulcanization bonding to a central portion of the second elastic body 27. A disc-shaped partition member 29 is fixed between an upper face of the second elastic body support ring 15 and the outer peripheral portion of the first elastic body 19. A first liquid chamber 30 defined by the partition member 29 and the first elastic body 19, and a second liquid chamber 31 defined by the partition member 29 and the second elastic body 27, communicate with each other via a through hole 29a formed in the middle of the partition member 29.

An annular through passage 32 is formed between the first elastic body support ring 14 and the upper housing 11. One end of the through passage 32 communicates with the first liquid chamber 30 via a through hole 33, and the other end of the through passage 32 communicates via a through hole 34 with a third liquid chamber 35 defined by the first elastic body 19 and the diaphragm 22.

The structure of an actuator 41 for driving the movable member 28 is now described.

Mounted within the actuator case 13 in sequence from the bottom to the top are a stationary core 42, a coil assembly 43, and a yoke 44. The coil assembly 43 is formed from a bobbinless coil 46 disposed between the stationary core 42 and the yoke 44, and a coil cover 47 covering the outer periphery of the bobbinless coil 46. The coil cover 47 is formed integrally with a connector 48 running through openings 13b and 12c formed in the actuator case 13 and the lower housing 12 and extending outward. A seal 49 is disposed between an upper face of the coil cover 47 and a lower face of the yoke 44. A seal 50 is disposed between a lower face of the bobbinless coil 46 and an upper face of the stationary core 42.

A thin cylindrical bearing member 51 is fitted, in a vertically slidable manner, into an inner peripheral face of a cylindrical portion 44a of the yoke 44. An upper flange 51a and a lower flange 51b are formed at the upper end and the lower end respectively of the bearing member 51, the upper flange 51a being bent radially inward, the lower flange 51b being bent radially outward. A set spring 52 is disposed in a compressed state between the lower flange 51b and the lower end of the cylindrical portion 44a of the yoke 44. The bearing member 51 is supported by the yoke 44 by the lower flange 51b being pressed against the upper face of the stationary core 42 via an elastic body 53 by means of the elastic force of the set spring 52.

A substantially cylindrical movable core 54 is fitted, in a vertically slidable manner, into an inner peripheral face of the bearing member 51. A rod 55, extending downward from the center of the movable member 28, runs loosely through the center of the movable core 54, and a nut 56 is tightened around the lower end of the rod 55. A set spring 58 is disposed in a compressed state between a spring seat 57 provided on an upper face of the movable core 54 and a lower face of the movable member 28. The movable core 54 is fixed by being pressed against the nut 56 by means of the elastic force of the set spring 58. In this state, the lower face of the movable core 54 and the upper face of the stationary core 42 face each other across a conical air gap g. The rod 55 and the nut 56 are loosely fitted into an opening 42a formed in the center of the stationary core 42, and the lower end of this opening 42a is blocked by a plug 60 via a seal 59. The seals 49, 50 and 59 can prevent water or dust from entering a sealed space 61 in the actuator 41 via the openings 13b, 12c and 42a formed in the actuator case 13, the lower housing 12 and the stationary core 42.

Outer peripheral edges of an annular bag 64 having a U-shaped section are joined by vulcanization bonding to an upper ring 62 and a lower ring 63, each of which are formed so as to have an L-shaped section. The upper ring 62 and the lower ring 63 are fixed by being interposed between a second elastic body support ring 15 and a yoke 44. A cut-out 63a is formed in one area of the upper edge of the lower ring 63 which is in intimate contact with the lower edge of the upper ring 62. The cut-out 63a faces a through hole 13c formed in the actuator case 13. Therefore, the interior of the bag 64, which is an elastic body disposed within a sealed space 61, is cut off from the sealed space 61, and communicates with the atmosphere via the cut-out 63a of the lower ring 63 and the through hole 13c of the actuator case 13.

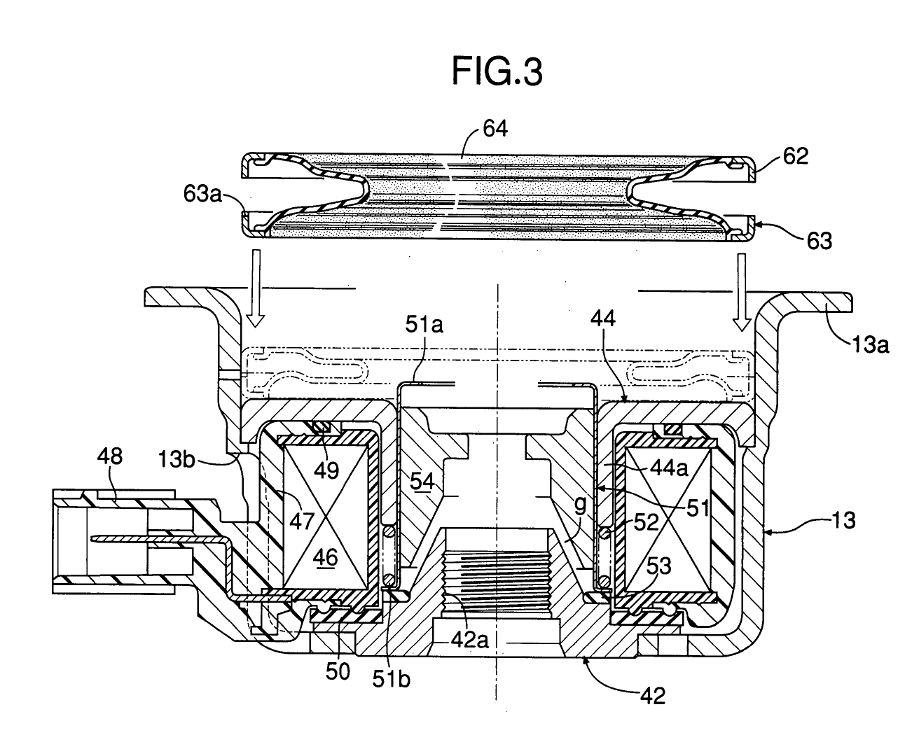

As shown in FIG. 3, the upper ring 62 and the lower ring 63, to which the bag 64 is joined by vulcanization bonding, are fixed within the actuator case 13 by being press-fitted into an inner peripheral face of the actuator case 13.

Returning to FIG. 1, an electronic control unit U, to which is connected a crank pulse sensor Sa for detecting a crank pulse that is outputted accompanying rotation of a crankshaft of the engine, controls the supply of current to the actuator 41 of the active vibration isolation support system M. The crank pulse of the engine is outputted 24 times per revolution of the crankshaft, that is, once every 15° of the crank angle.

The operation of the first embodiment of the present invention having the above-mentioned arrangement are now described.

When low frequency engine shake vibration occurs while the automobile is traveling, the first elastic body 19 is deformed by a load input from the engine via the diaphragm support boss 20 and the first elastic body support boss 18, thus changing the capacity of the first liquid chamber 30, so that a liquid moves to and fro between the first liquid chamber 30 and the third liquid chamber 35 via the through passage 32. When the capacity of the first liquid chamber 30 increases/decreases, the capacity of the third liquid chamber 35 decreases/increases correspondingly, and this change in the capacity of the third liquid chamber 35 is absorbed by elastic deformation of the diaphragm 22. The shape and the dimensions of the through passage 32 and the spring constant of the first elastic body 19 are set so that a low spring constant and high attenuation force are exhibited in the frequency region of the engine shake vibration. Therefore, it is possible to effectively suppress the vibration transmitted from the engine to the vehicle body frame.

In the frequency region of the engine shake vibration, the actuator 41 is maintained in a non-operating state.

When there is vibration having a higher frequency than that of the above-mentioned engine shake vibration, that is, vibration during idling or vibration during cylinder cut-off due to rotation of the engine crankshaft, the liquid within the through passage 32 providing communication between the first liquid chamber 30 and the third liquid chamber 35 becomes stationary and a vibration isolation function cannot be exhibited; the actuator 41 is therefore driven to exhibit a vibration isolation function.

In order to operate the actuator 41 of the active vibration isolation support system M to exhibit the vibration isolation function, the electronic control unit U controls the supply of current to the bobbinless coil 46 based on a signal from the crank pulse sensor Sa.

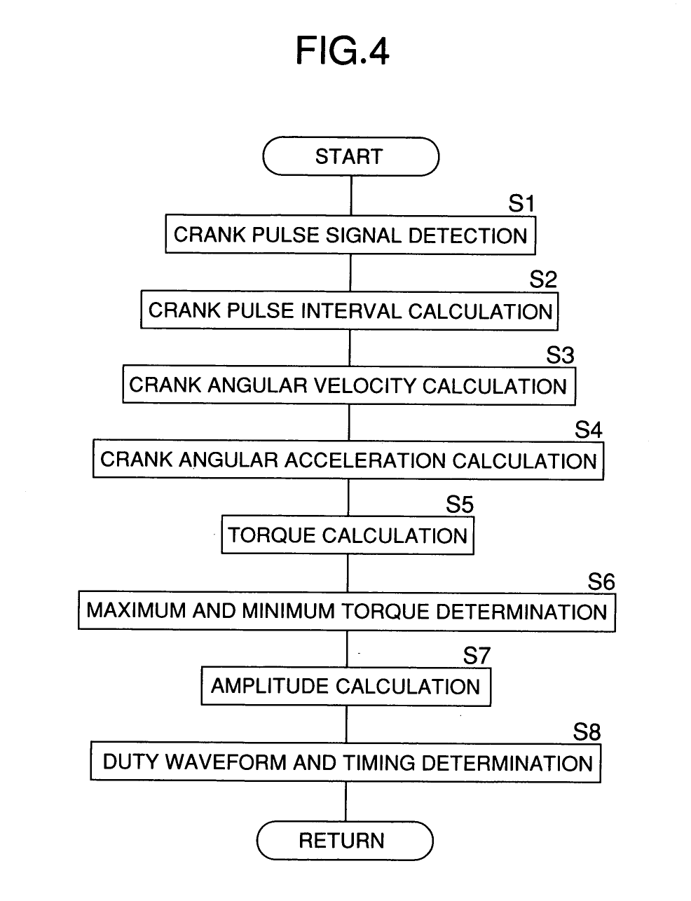

That is, in the flow chart of FIG. 4, firstly in step S1, crank pulses output from the crank pulse sensor Sa every 15° of crank angle are read in. In step S2, the crank pulses thus read in are compared with a reference crank pulse (TDC signal of a specified cylinder) so as to calculate a time interval between the crank pulses. In step S3, a crank angular velocity ω is calculated by dividing the 15° crank angle by the time interval between the crank pulses. In step S4, a crank angular acceleration dω/dt is calculated by differentiating the crank angular velocity ω with respect to time. In step S5, a torque Tq around the engine crankshaft is calculated from
Tq=I×dω/dt,
where I is the moment of inertia around the engine crankshaft. This torque Tq becomes 0 if it is assumed that the crankshaft rotates at a constant angular velocity ω, but in an expansion stroke the angular velocity ω increases by acceleration of a piston, and in a compression stroke the angular velocity ω decreases by deceleration of the piston, thus generating a crank angular acceleration dω/dt; as a result a torque Tq that is proportional to the crank angular acceleration dω/dt is generated.

In step S6, a maximum value and a minimum value of two successive torque values are determined. In step S7, amplitude at the position of the active vibration isolation support system M supporting the engine is calculated as the difference between the maximum value and the minimum value of the torque, that is, a torque variation. In step S8, a duty waveform and timing (phase) of current applied to the bobbinless coil 46 of the actuator 41 are determined.

Thus, when the engine moves downward relative to the vehicle body frame and the first elastic body 19 is deformed downwardly thereby decreasing the capacity of the first liquid chamber 30, energizing the bobbinless coil 46 of the actuator 41 with matching timing allows the movable core 54 to move downward toward the stationary core 42 by means of the attractive force generated in the air gap g, and the second elastic body 27 is deformed downwardly by being drawn by the movable member 28 connected to the movable core 54 via the rod 55. As a result, the capacity of the second liquid chamber 31 increases, so that the liquid in the first liquid chamber 30 which is compressed by the load from the engine, passes through the through hole 29a of the partition member 29 and flows into the second liquid chamber 31, thereby reducing the load transmitted from the engine to the vehicle body frame.

Subsequently, when the engine moves upward relative to the vehicle body frame and the first elastic body 19 is deformed upwardly thereby increasing the capacity of the first liquid chamber 30, de-energizing the bobbinless coil 46 of the actuator 41 with matching timing allows the attractive force generated in the air gap g to disappear and the movable core 54 to move freely, so that the second elastic body 27 that has been deformed downwardly recovers upwardly by its own elastic recovery force. As a result, the capacity of the second liquid chamber 31 decreases, and the liquid in the second liquid chamber 31 passes through the through hole 29a of the partition member 29 and flows into the first liquid chamber 30, thereby allowing the engine to move upward relative to the vehicle body frame.

In this way, by energizing and de-energizing the bobbinless coil 46 of the actuator 41 according to the cycle of vibration of the engine, it is possible to generate an active damping force that prevents vibration of the engine from being transmitted to the vehicle body frame.

As described above, since the sealed space 61 is cut off from the outside and sealed, it is possible to reliably prevent dust or water from entering the sealed space 61. Thus, it is possible to prevent malfunction due to dust or water becoming attached to sliding portions between the movable core 54 and the bearing member 51 disposed in the sealed space 61.

Furthermore, since the movable member 28 and the second elastic body 27 face the sealed space 61, when the pressure of the sealed space 61 becomes higher than atmospheric pressure as a result of an increase in the ambient temperature or heat generation in the actuator 41 itself, the second elastic body 27 is deformed upward so as to raise the neutral position of the movable member 28, and as a result an air gap g beneath the movable core 54 increases and the attractive force of the actuator 41 decreases. In contrast, when the ambient temperature decreases and the pressure of the sealed space 61 becomes lower than atmospheric pressure, the second elastic body 27 is deformed downward so as to lower the neutral position of the movable member 28, and as a result the air gap g beneath the movable core 54 decreases and the attractive force of the actuator 41 increases.

In this way, if the neutral positions of the second elastic body 27 and the movable member 28 change due to a variation in the pressure of the sealed space 61, there is a problem that the precision is degraded in controlling the amplitude of the movable member 28 by the actuator 41.

However, in this embodiment, when the pressure of the sealed space 61 is going to increase, the bag 64, which communicates with the atmosphere via the through hole 13c, contracts so as to suppress an increase in the pressure of the sealed space 61; whereas when the pressure of the sealed space 61 is going to decrease, the bag 64, which communicates with the atmosphere, expands so as to suppress a decrease in the pressure of the sealed space 61. That is, the pressure of the sealed space 61 is always maintained at substantially atmospheric pressure. As a result, it is possible to prevent degradation in the precision in controlling the amplitude of the movable member 28 due to variation in the pressure of the sealed space 61, and to enhance the vibration isolating effect of the active vibration isolation support system M.

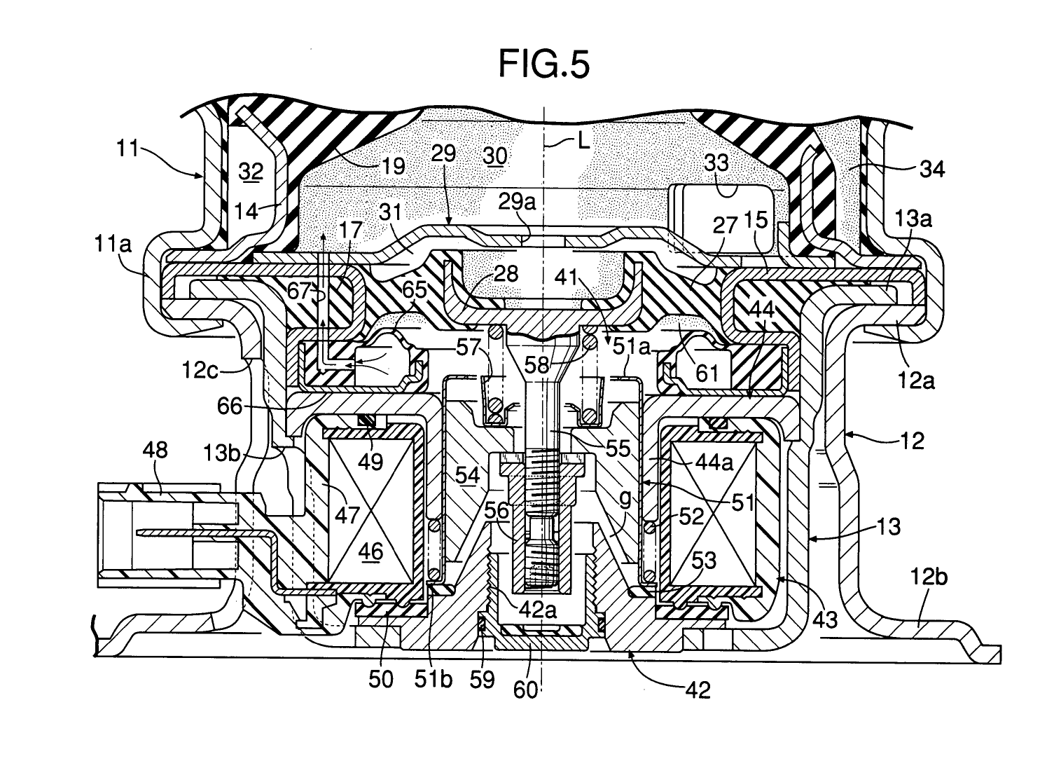

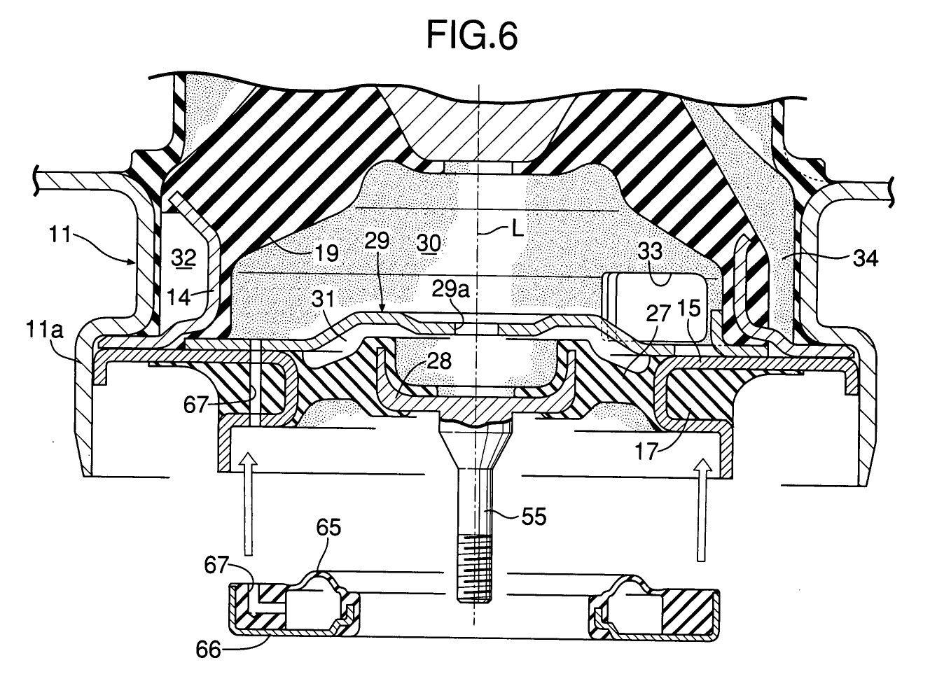

FIG. 5 and FIG. 6 show a second embodiment of the present invention wherein FIG. 5 is a diagram corresponding to FIG. 2, and FIG. 6 is a diagram for explaining a method of fixing the bag of FIG. 5 within the sealed space.

Although the bag 64 of the first embodiment communicates with the atmosphere via the through hole 13c, a bag 65 of the second embodiment communicates with a first liquid chamber 30. That is, the bag 65, which is integrally joined by vulcanization bonding to a ring 66, is press-fitted from below into the inner periphery of a second elastic body support ring 15, and fixed by being interposed between a yoke 44 which is assembled from below and the second elastic body support ring 15. The internal space of the bag 65 and the first liquid chamber 30 communicate with each other via a through hole 67 running through the bag 65, the second elastic body support ring 15, and a partition member 29.

The interior of the through hole 67 and the bag 65 are filled with a liquid of the first liquid chamber 30. Since the first liquid chamber 30 communicates with a third liquid chamber 35 which is defined by an easily deformable diaphragm 22, the first liquid chamber 30 is maintained at substantially atmospheric pressure, and therefore the interior of the bag 65 is maintained at substantially atmospheric pressure. With this arrangement, even if the movable member 28 and the second elastic body 27 move up and down accompanying operation of the actuator 41 and thus the capacity of a sealed space 61 changes, it is possible to absorb the change in the capacity by expansion and contraction of the bag 65 having an elasticity, and to maintain the pressure of the sealed space 61 at substantially atmospheric pressure. As a result, it is possible to prevent degradation in the precision in controlling the amplitude of the movable member 28 due to variation in the pressure of the sealed space 61, and to enhance the vibration isolating effect of the active vibration isolation support system M.

Although the embodiments of the present invention have been described above, various modifications in design can be made thereto without deviating from the subject matter of the present invention.

For example, in the embodiments, the pressure cushioning member comprises the bag 64 or 65 which is filled with air at atmospheric pressure or a liquid at atmospheric pressure, but the pressure cushioning member may comprise fine through holes which provide communication between the sealed space 61 and the atmosphere without allowing dust or water to pass therethrough.

What is claimed is:

1. An active vibration isolation support system comprising:
an elastic body that receives a load from a vibrating body;
a liquid chamber having a wall of which at least a part is formed from the elastic body;
an actuator that operates by receiving a supply of current according to a vibrational state of the vibrating body, the actuator comprising an armature; and
a movable member that is moved out and back by the armature so as to change a capacity of the liquid chamber;
at least the armature being housed in a sealed space that is cut off from the atmosphere, and the movable member facing the sealed space,
wherein a pressure cushioning member is provided for maintaining a pressure of the sealed space at substantially atmospheric pressure.

2. The active vibration isolation support system according to claim 1, wherein the pressure cushioning member comprises a flexible bag that is disposed within the sealed space and communicates with the atmosphere via a through hole formed in a wall defining the sealed space.

3. The active vibration isolation support system according to claim 1, wherein the pressure cushioning member comprises a flexible bag that is disposed within the sealed space and communicates with the liquid chamber via a through hole formed in a wall defining the sealed space.

4. The active vibration isolation support system according to claim 2, wherein the flexible bag is annular in shape.

5. The active vibration isolation support system according to claim 2, wherein the flexible bag is fixed to an inner peripheral face of an actuator housing.

6. The active vibration isolation support system according to claim 2, wherein
the pressure cushioning member further comprises a rigid annular ring,
the flexible bag comprises a U-shaped section, and
outer peripheral edges of the flexible bag are joined to the annular ring to form an elastic annular body.

7. The active vibration isolation support system according to claim 2 wherein the wall comprises a through hole formed in a housing of the actuator.

8. The active vibration isolation support system according to claim 3, wherein the flexible bag is annular in shape.

9. The active vibration isolation support system according to claim 3, wherein the flexible bag is fixed to a portion of the wall which provides a barrier between the actuator and the liquid chamber.

10. The active vibration isolation support system according to claim 3, wherein
the pressure cushioning member further comprises a rigid annular ring, and
outer peripheral edges of the flexible bag are joined to the annular ring to form an elastic annular body.

11. The active vibration isolation support system according to claim 3 wherein the wall comprises a through hole which permits liquid to flow between an interior of the flexible bag and the liquid chamber.

12. An active vibration isolation support system comprising:
an elastic body that receives a load from a vibrating body;
a liquid chamber having a wall of which at least a part is formed from the elastic body;
an actuator that operates by receiving a supply of current according to a vibrational state of the vibrating body, the actuator comprising an armature; and
a movable member that is moved out and back by the armature so as to change a capacity of the liquid chamber;
at least the armature being housed in a sealed space that is cut off from the atmosphere, and the movable member facing the sealed space,
wherein a pressure cushioning member is provided for maintaining a pressure of the sealed space at substantially atmospheric pressure, and
the pressure cushioning member comprises a flexible bag that is disposed within the sealed space and communicates with the exterior of the sealed space via a through hole formed in a wall defining the sealed space.

13. The active vibration isolation support system according to claim 12, wherein the flexible bag communicates with the atmosphere via the through hole which is formed in a wall between the sealed space and the atmosphere.

14. The active vibration isolation support system according to claim 12, wherein the flexible bag communicates with the liquid chamber via the through hole which is formed in a wall between the sealed space and the liquid chamber.
